(19) United States
(12) Patent Application Publication
(10) Pub. No.: US 2007/0160216 A1
(43) Pub. Date: Jul. 12, 2007

(54) Acoustic synthesis and spatialization method

(75) Inventors: Rozenn Nicol, La Roche Derrien (FR); David Virette, Lannion (FR); Marc Emerit, Rennes (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 10/582,834

(22) PCT Filed: Dec. 15, 2003
(86) PCT No.: PCT/FR03/03730

§ 371 Date: Jun. 14, 2006

(51) Int. Cl. H04R 5/00; G10H 1/46

(52) U.S. Cl. 381/17; 84/633

(57) ABSTRACT

The invention relates to the synthesis and the joint spatialization of sounds emitted by virtual sources. According to the invention, a step (ETA) is provided that consists of determining parameters including at least one gain (gi) for defining, at the same time, a loudness characterizing the nature of the virtual source and the position of the source relative to a predetermined origin.

The present invention relates to the synthesis of audio signals, in particular in applications for editing music, video games or even ring tones for cell phones.

More particularly, the invention relates to both acoustic synthesis techniques and three-dimensional (3D) sound techniques.

To offer innovative services, based on acoustic synthesis (to create ring tones, or even in the context of games on cell phones), efforts are currently focused on enhancing the acoustic synthesis methods. However, since the terminals are limited in terms of memory and computation power, it is preferable to develop methods that are both effective and economical in terms of complexity.

Acoustic Synthesis Techniques

Numerous acoustic synthesis techniques have been developed in recent years. It should be pointed out that, in reality, there is no universal technique capable of generating just any sound. In practice, the production models that have been created until now all have their restrictions. A classification established by Julius Smith in:

“Viewpoints on the History of Digital Synthesis”, Smith J. O; Keynote paper, Proc. Int. Comp. Music Conf. 1991, Montreal,

is outlined below.

The techniques are categorized in four groups:
calculative techniques (frequency modulation FM, waveshaping, etc.),
sampling and other recording processes (for example, wavetable synthesis, etc.),
techniques based on spectral models (such as additive synthesis or even the so-called “source-filter”, etc.),
techniques based on physical models (modal synthesis, waveguide synthesis, etc.).

Some techniques, depending on their use, may fall into a number of categories.

The choice of the synthesis technique suited to a terminal or to a rendition system can be made on the basis of three families of criteria, in particular criteria of the type of those proposed by the signal acoustics and processing laboratory of the University of Helsinki, as part of an assessment of the different synthesis methods:

“Evaluation of Modern Sound Synthesis Methods”, Tolonen T., Valimaki, V., Karjalainen M; Report 48, Espoo 1998.

A first family of criteria concerns the use of the following parameters:
intuitiveness,
perceptibility,
physical sense,
and behavior.

The quality and diversity of the sounds that are produced determine the second family of criteria, according to the following parameters:
robustness of the identity of the sound,
extent of the sound pallet, and
with a preliminary analysis phase, where appropriate.

Finally, the third family of criteria deals with implementation solutions, with parameters such as:
computation cost,
memory needed,
control, latency and multi-tasking processes.

It has recently emerged that the techniques relying on a spectral modeling (with reproduction of the spectral image perceived by a listener) or a physical modeling (with simulation of the physical origin of the sound) are the most satisfactory and offer wide potential for future systems.

However, currently, the methods based on wavetable synthesis are the most widely used. The principle of this technique is as follows. Firstly, all the natural audio signals can be broken down into four phases: attack, decay, sustain and release, generally grouped under the term “ADSR envelope” (Attack, Decay, Sustain, Release envelope), which will be described later.

The wavetable synthesis principle consists in taking one or more signal periods (corresponding to a recording or to a synthetic signal), then applying processes to it (with looping, change of fundamental frequency, etc.) and finally applying the abovementioned ADSR envelope to it. This very simple synthesis method makes it possible to obtain satisfactory results. A technique similar to wavetable synthesis is the one known as “sampling” which is, however, distinguished by the fact that it uses recordings of natural signals instead of synthetic signals.

Another example of simple synthesis is synthesis by frequency modulation, more widely known as “FM synthesis”. In this case, a frequency modulation is performed for which the frequency of the modulating signal and the carrier signal (fₘ and f_{c}) is located in the audible range (20 to 20 000 Hz). It shall also be indicated that the respective amplitudes of the harmonics relative to the fundamental mode can be chosen to define a sound timbre.

There are different transmission formats for the information intended for the sound synthesizers. Firstly, a score can be transmitted in MIDI formats or according to the MPEG4-Structured Audio standard for it then to be synthesized by the chosen acoustic synthesis technique. In some systems, it is also possible to transmit information on the instruments to be used by the synthesizer, for example using the DLS format which allows the information necessary for wavetable sound synthesis to be transmitted. Similarly, algorithmic languages of the “CSound” or “MPEG-4 SAOL” type make it possible to represent the sounds by acoustic synthesis technique.

The present invention relates to the combination of acoustic synthesis with the spatialization of sounds obtained from this synthesis. A few known acoustic spatialization techniques are summarized below.

Acoustic Spatialization Techniques

These are methods of processing the audio signal applied to the simulation of acoustic and psycho-acoustic phenomena. These techniques are aimed at generating signals to be transmitted to loudspeakers or to headphones, in order to give the listener the auditory illusion of acoustic sources placed in a predetermined position around him. They are advantageously applied in the creation of virtual acoustic sources and images.

Among the acoustic spatialization techniques, there are mainly two categories.

The methods based on a physical approach generally consist in reproducing the acoustic field like the original acoustic field within an area of finite dimensions. These methods do not take into account a priori the perceptive properties of the auditory system, in particular in terms of auditory location. With such systems, the listener is thus immersed in a field that is at all points identical to that which he would have perceived in the presence of the actual sources and he can therefore locate the acoustic sources as in a real listening situation.

The methods based on a psycho-acoustic approach seek rather to exploit 3D sound perception mechanisms in order to simplify the sound reproduction process. For example, instead of reproducing the acoustic field over an entire area, it is possible to make do with reproducing it only at the two ears of the listener. Similarly, it is possible to impose a faithful reproduction of the acoustic field over a fraction of the spectrum only, in order to relax the constraint on the rest of the spectrum. The objective is to take account of the perception mechanisms of the auditory system in order to identify the minimum quantity of information to be reproduced to obtain a psycho-acoustic field identical to the original field, that is such that the ear, because of the limitations of its performance, is incapable of distinguishing them from each other.

In the first category, different techniques have been identified:
holophony, which is typically a technique of physically reconstructing an acoustic field, since it constitutes the acoustic equivalent of holography. It consists in reproducing an acoustic field based on a recording on a surface (hollow sphere or other). More details can be obtained from:
“Restitution sonore spatialisée sur une zone étendue: Application à la téléprésence” Spatialized acoustic reproduction over a wide area: Application to telepressence, R. Nicol; University of Maine Thesis, 1999;
the ambisonic technique, which is another example of physical reconstruction of the acoustic field, using a breakdown of the acoustic field based on specific functions, called “spherical harmonics”.

In the second category, there are, for example:
stereophony, which exploits time or intensity differences to position the acoustic sources between two loudspeakers, based on the inter-aural time and intensity differences that define the perceptive criteria for auditory location in a horizontal plane;
the binaural techniques which seek to reconstruct the acoustic field only at the ears of the listener, such that the eardrums perceive an acoustic field identical to that which would have been induced by the actual sources.

Each technique is characterized by a specific method of encoding and decoding spatialization information in an appropriate audio signal format.

The different acoustic spatialization techniques are also distinguished by the extent of the spatialization that they provide. Typically, a 3D spatialization such as ambisonic encoding, holophony, binaural or transaural synthesis (transaural synthesis being a transposition of the binaural technique on two remote loudspeakers), includes all the directions of the space. Moreover, a two-dimensional (2D) spatialization, such as stereophony, or a 2D restriction of holophony or of the ambisonic technique, is limited to the horizontal plane.

Finally, the different techniques are distinguished by their possible delivery systems, for example:
delivery by headset for the binaural or stereophony techniques,
delivery by two loudspeakers, in particular for stereophony or for a transaural system,
or a delivery over a network of more than two loudspeakers, for an extended listening area (in particular for multi-listener applications), in holophony or in ambisonic reproduction.

There is a wide range of current devices offering acoustic synthesis capabilities. These devices range from the musical instrument (such as a keyboard, a rhythm box, or other), mobile terminals, of PDA (Personal Digital Assistant) type, for example, or even computers with music editing software installed, or even effects pedal assemblies equipped with a MIDI interface. The sound reproduction systems (headset, stereo loudspeakers or multiple loudspeaker systems) and the quality of the acoustic synthesis systems vary widely, in particular according to the more or less limited computation capabilities and according to the environments in which such systems are used.

Systems capable of spatializing previously synthesized sounds, in particular by a cascading of an acoustic synthesis engine and a spatialization engine, are currently known. The spatialization is then applied to the output signal from the synthesizer (on a mono channel or two stereo channels) after mixing of the different sources. Implementations of this solution for then spatializing the sounds obtained from a synthesizer are thus known.

More generally known are implementations consisting in 3D rendition engines, which can be applied to any type of digital audio signals, whether synthetic or not. For example, the different musical instruments of a MIDI score (conventional acoustic synthesis format) can then be positioned in the acoustic space. However, to obtain such a spatialization, the MIDI signals must first be converted into digital audio signals and then a spatialization processing must be applied to the latter.

This implementation is particularly costly in terms of processing time and processing complexity.

One aim of the present invention is an acoustic synthesis method offering the possibility of directly spatializing the synthetic sounds.

More particularly, an aim of the present invention is to associate with the acoustic synthesis spatialization tools of satisfactory quality. However, this association compounds the complexity due to the acoustic synthesis with that of the spatialization, which makes it difficult to implement a spatialized acoustic synthesis on very restricted terminals (that is, terminals with relatively limited computation power and memory).

Another aim of the present invention is to achieve an optimization of the complexity involved in spatializing synthetic sounds according to the capabilities of the terminal.

To this end, the present invention firstly proposes an acoustic synthesis and spatialization method, in which a synthetic sound to be generated is characterized by the nature of a virtual acoustic source and by its position relative to a chosen origin.

The method according to the invention comprises a joint step consisting in determining parameters including at least one gain, for defining at the same time:
a loudness characterizing the nature of the source, and
the position of the source relative to a predetermined origin.

It will thus be understood that the present invention allows a sound spatialization technique to be integrated in an acoustic synthesis technique, so as to obtain a global processing using common parameters for the implementation of the two techniques.

In an embodiment, the spatialization of the virtual source is carried out in an ambisonic context. The method then includes a step for computing gains associated with ambisonic components in a spherical harmonics base.

In a variant, the synthetic sound is intended to be reproduced in a holophonic, or binaural, or transaural context, on a plurality of reproduction channels. It will be understood in particular that this “plurality of reproduction channels” can equally relate to two reproduction channels, in a binaural or transaural context, or even more than two reproduction channels, for example in a holophonic context. During said joint step, a delay between reproduction channels is also determined, to define at the same time:
a triggering instant of the sound characterizing the nature of the source, and
the position of the source relative to a predetermined origin.

In this embodiment, the nature of the virtual source is parameterized at least by a temporal loudness variation, over a chosen duration and including a sound triggering instant. In practice, this temporal variation can advantageously be represented by an ADSR envelope as described above.

Preferably, this variation comprises at least:
an instrumental attack phase,
a decay phase,
a sustain phase, and
a release phase.

Of course, more complex envelope variations can be envisaged.

The spatialization of the virtual source is preferably performed by a binaural synthesis based on a linear breakdown of transfer functions, these transfer functions being expressed by a linear combination of terms dependent on the frequency of the sound and weighted by terms dependent on the direction of the sound. This measure proves advantageous in particular when the position of the virtual source can change over time and/or when a number of virtual sources are to be spatialized.

Preferably, the direction is defined by at least one bias angle (for a spatialization in a single plane) and, preferably, by a bias angle and an elevation angle (for a three-dimensional spatialization).

In the context of a binaural synthesis based on a linear breakdown of the transfer functions, the position of the virtual source is advantageously parameterized at least by:
a number of filterings, dependent on the acoustic frequency,
a number of weighting gains each associated with a filtering, and
a delay for each “left” and “right” channel.

Preferably, the nature of the virtual source is parameterized at least by one acoustic timbre, by associating the chosen relative loudnesses with harmonics of a frequency corresponding to a pitch of the sound. In practice, this modeling is advantageously carried out by an FM synthesis, described above.

In an advantageous embodiment, an acoustic synthesis engine is provided, specifically for generating spatialized sounds, relative to a predetermined origin.

Preferably, the synthesis engine is implemented in a music editing context, and a man-machine interface is also provided for, to place the virtual source in a chosen position relative to the predetermined origin.

To synthesize and spatialize a plurality of virtual sources, each source is assigned to a respective position, preferably by using a linear breakdown of the transfer functions in a binaural context, as indicated above.

The present invention aims also at a module for generating synthetic sounds, comprising in particular a processor, and including in particular a working memory specifically for storing instructions for implementing the above method, so as to process simultaneously a synthesis and a spatialization of the sound, according to one of the advantages of the present invention.

To this end, the present invention aims also at a computer program product, stored in a memory of a central processing unit or a terminal, in particular a mobile terminal, or on a removable medium specifically for cooperating with a drive of said central processing unit, and comprising instructions for implementing the above method.

Other characteristics and advantages of the invention will become apparent from examining the detailed description below, and the appended drawings in which:

FIG. 1 diagrammatically illustrates acoustic source positions i and microphone positions j in the three-dimensional space,

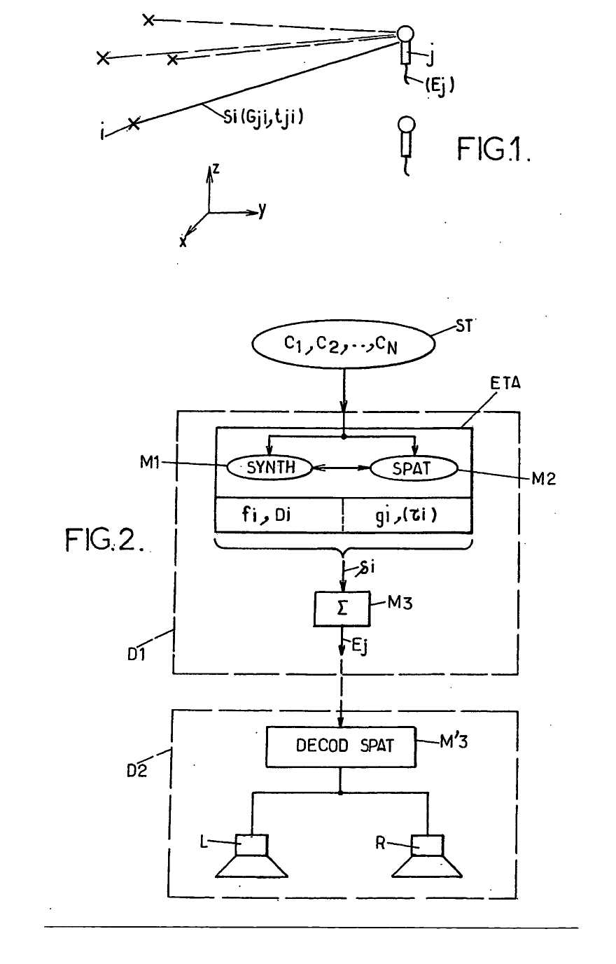

FIG. 2 diagrammatically represents a simultaneous acoustic spatialization and synthesis processing, in the sense of the invention,

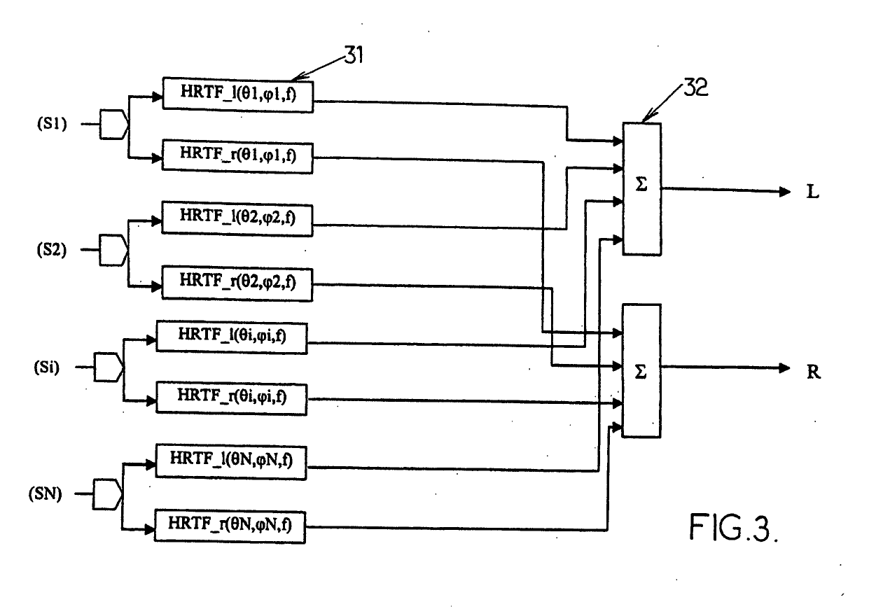

FIG. 3 diagrammatically represents the application of transfer functions HRTFs to signals Sᵢ for a spatialization in binaural or transaural synthesis mode,

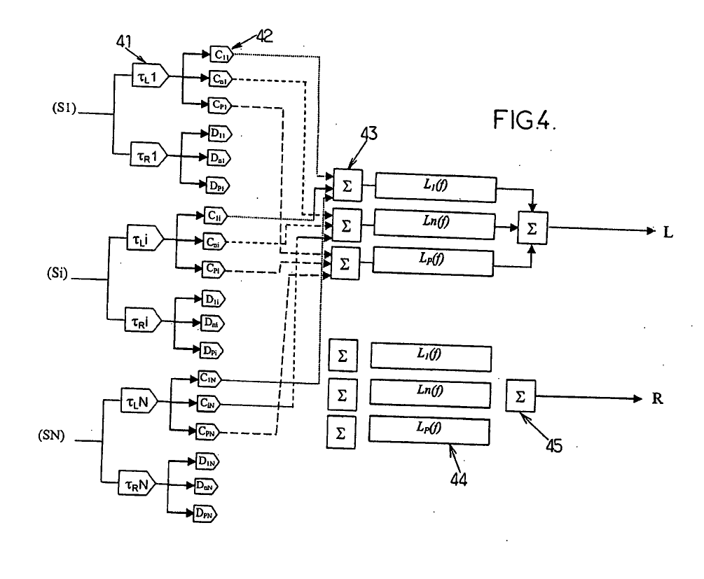

FIG. 4 diagrammatically represents the application of a pair of delays (one delay for each left or right channel) and several gains (one gain for each directional filter) in binaural or transaural synthesis mode, using the linear breakdown of the HRTFs,

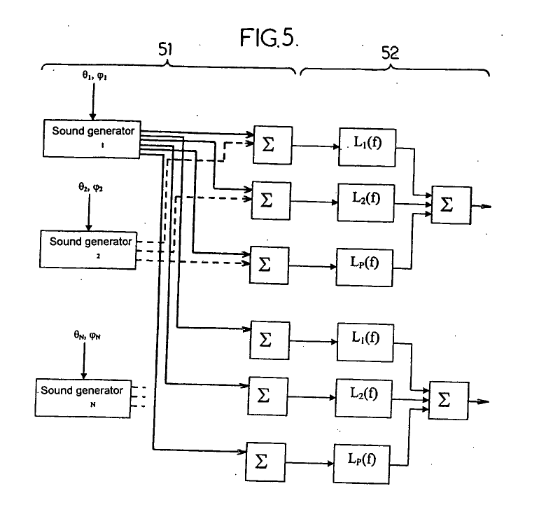

FIG. 5 diagrammatically represents the integration of the spatialization processing, within a plurality of synthetic sound generators, for an acoustic spatialization and synthesis in a single step,

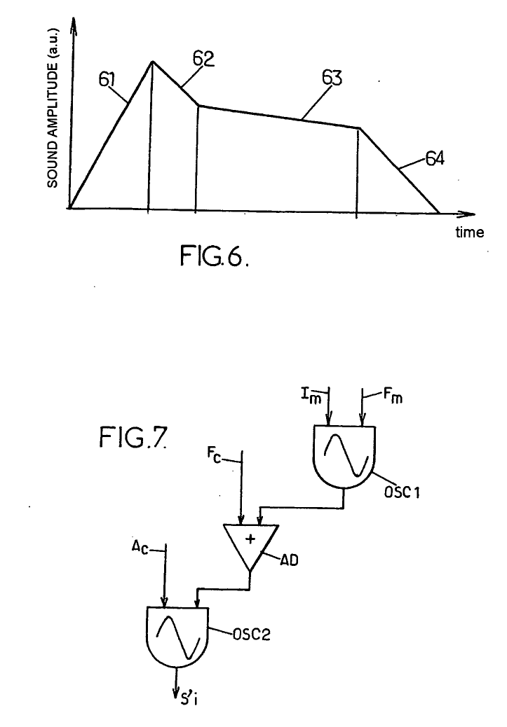

FIG. 6 represents a model ADSR envelope in acoustic synthesis mode,

and FIG. 7 diagrammatically represents a sound generator in FM synthesis mode.

It will be remembered that the present invention proposes to integrate a sound spatialization technique with an acoustic synthesis technique so as to obtain a global, optimized, spatialized acoustic synthesis processing. In the context of very restricted terminals, the pooling of certain of the acoustic synthesis operations, on the one hand, and acoustic spatialization operations on the other hand, proves of particular interest.

As a general rule, the function of an acoustic synthesis engine (typically a “synthesizer”) is to generate one or more synthetic signals, based on a sound synthesis model, a model that is driven based on a set of parameters, called “synthesis parameters” below. The synthetic signals generated by the synthesis engine can correspond to separate acoustic sources (which are, for example, the different instruments of a score) or can be associated with one and the same source, for example in the case of different notes from one and the same instrument. Hereinafter, the term “sound generator” denotes a module for producing a musical note. Thus, it will be understood that a synthesizer is made up of a set of sound generators.

Also as a general rule, an acoustic spatialization tool is a tool that accepts a given number of audio signals as input, these signals being representative of acoustic sources and, in principle, without any spatialization processing. It should be indicated in fact that, if these signals have already been subjected to a spatialized processing, this prior processing is not taken into account here. The role of the spatialization tool is to process the input signals, according to a scheme that is specific to the chosen spatialization technique, to generate a given number of output signals which define the spatialized signals representative of the acoustic scene in the chosen spatialization format. The nature and complexity of the spatialization processing depend obviously on the chosen technique, according to whether it is a rendition in stereophonic, binaural, holophonic or ambisonic format that is being considered.

More particularly, for many spatialization techniques, it appears that the processing can be reduced to an encoding phase and a decoding phase, as will be seen later.

The encoding corresponds to the sound pick-up of the acoustic field generated by the different sources at a given instant. This “virtual” sound pick-up system can be more or less complex depending on the acoustic spatialization technique adopted. Thus, a sound pick-up by a more or less large number of microphones with different positions and directivities is simulated. In all cases, the encoding amounts, for calculating the contribution of an acoustic source, at least to the application of gains and, more often than not, delays (typically in holophony or in binaural or transaural synthesis), to different copies of the signal sent by the source. There is one gain (and, where appropriate, one delay) per source for each virtual microphone. This gain (and this delay) depend on the position of the source relative to the microphone. If there is provided a virtual sound pick-up system equipped with K microphones, there are K signals output from the encoding system.

Referring to FIG. 1, the signal Eⱼ represents the sum of the contributions of all the acoustic sources on the microphone j. Furthermore:
Sᵢ denotes the sound sent by the source i,
Eⱼ denotes the encoded signal at the output of the microphone j,
Gⱼᵢ denotes the attenuation of the sound Sᵢ due to the distance between the source i and the microphone j, the directivity of the source, the obstacles between the source i and the microphone j, and finally the very directivity of the microphone j,
tⱼᵢ denotes the delay of the sound Sᵢ due to the propagation from the source i to the microphone j, and
x, y, z denote the cartesian coordinates of the position of the source, assumed variable in time.

The encoded signal Eⱼ is given by the expression:

$$Ej ( t ) = {\sum }_{i = 1}^{L} δ ( t - tji ( x , y , z ) ) * Gji ( x , y , z ) Si ( t )$$

In this expression, it is assumed that L sources (i=1, 2, . . . , L) have to be processed, whereas the encoding format provides for K signals (j=1, 2, . . . , K). The gains and the delays depend on the position of the source i relative to the microphone j at the instant t. The encoding is therefore a representation of the acoustic field generated by the acoustic sources at that instant j. It is simply recalled here that, in an ambisonic context (consisting of a breakdown of the field in a spherical harmonics base), the delay does not actually contribute to the spatialization processing.

In the case where the acoustic sources are in a room, the image sources must be added. These are images of the acoustic sources reflected by the walls of the room. The image sources, by being reflected in turn on the walls, generate higher order image sources. In the above expression, L therefore no longer represents the number of sources, but the number of sources to which are added the number of image sources. The number of image sources is infinite, which is why, in practice, only the audible image sources and those for which the direction is perceived are kept. The image sources that are audible but for which the direction can no longer be perceived are grouped and their contribution is synthesized using an artificial reverberator.

The aim of the decoding step is to reproduce the encoded signals Eⱼ on a given device, comprising a predetermined number T of acoustic transducers (headset, loudspeaker). This step consists in applying a matrix T×K of filters to the encoded signals. This matrix depends only on the rendition device, and not on the acoustic sources. Depending on the encoding and decoding technique chosen, this matrix can be very simple (for example identity) or very complex.

FIG. 2 diagrammatically represents a flow diagram showing the abovementioned various steps. A first step ST constitutes a start-up step during which a user defines sound commands C₁, C₂, . . . , C_{N} to be synthesized and spatialized (for example, by providing a man-machine interface to define a musical note, an instrument to play this note and a position of this instrument playing this note in space). As a variant, for example for the spatialization of the sound with a mobile terminal, the spatialization information can be transmitted in a stream parallel to the synthetic audio stream, or even directly in the synthetic audio stream.

Then, it should be indicated that the invention advantageously provides a single step ETA for the joint synthesis and spatialization of the sound. As a general rule, a sound can be defined at least by:
the frequency of its fundamental mode, characterizing the pitch,
its duration,
and its loudness.

Thus, in the example of a synthesizer with sensitive keypad, if the user plays a forte note, the loudness associated with the command Cᵢ will be greater than the loudness associated with a piano note. More specifically, it should be indicated that the loudness parameter can, as a general rule, take into account the spatialization gain gᵢ in a spatialization processing context, as will be seen below, according to one of the major advantages of the present invention.

Furthermore, a sound is, of course, also defined by its triggering instant. Typically, if the chosen spatialization technique is not an ambisonic processing, but rather binaural or transaural synthesis, holophony or other, the spatialization delay τᵢ (which will be described in detail below) can be used to also control the triggering instant of the sound.

By referring again to FIG. 2, an acoustic synthesis and spatialization device D1 comprises:
a synthesis module proper M1, capable of defining, according to a command Cᵢ, at least the frequency fᵢ and the duration Dᵢ of the sound i associated with this command Cᵢ, and
a spatialization module M2, capable of defining at least the gain gᵢ (in an ambisonic context in particular) and, also, the spatialization delay τᵢ in holophony or binaural or transaural synthesis.

As indicated above, the latter two parameters gᵢ and τᵢ can be used jointly for the spatialization, but also for the very synthesis of the sound, when a loudness (or a pan in stereophony) and a triggering instant of the sound are defined.

More generally, it should be indicated that, in a preferred embodiment, the two modules M1 and M2 are grouped in one and the same module to allow for the definition in one and the same step of all the parameters of the signal sᵢ to be synthesized and spatialized: its frequency, its duration, its spatialization gain, its spatialization delay, in particular.

These parameters are then applied to an encoding module M3 of the acoustic synthesis and spatialization device D1. Typically, for example in binaural or transaural synthesis, this module M3 carries out a linear combination on the signals sᵢ which involves in particular the spatialization gains, as will be seen below. This encoding module M3 can also apply a compression mode encoding to the signals sᵢ to prepare for a transmission of the encoded data to a reproduction device D2.

It should be indicated, however, that this encoding module M3 is, in a preferred embodiment, directly incorporated in the modules M1 and M2 above, so as to create directly, within a single module D1 which would consist simply of an acoustic synthesis and spatialization engine, the signals Eⱼ as if they were delivered by microphones j, as explained above.

Thus, the acoustic synthesis and spatialization engine D1 produces, at the output, K acoustic signals Eⱼ representing the encoding of the virtual acoustic field that the different synthetic sources would have created if they had been real. At this stage, there is a description of an acoustic scene in a given encoding format.

Of course, provision can also be made to add (or “mix”) to this acoustic scene other scenes originating from an actual sound pick-up or from the output of other sound processing modules, provided that they are in the same spatialization format. The mixing of these different scenes then passes into a particular and unique decoding system M′3, provided at the input of a reproduction device D2. In the example represented in FIG. 2, this reproduction device D2 comprises two channels, in this case for a binaural reproduction (reproduction on stereophonic headset) or transaural reproduction (reproduction on two loudspeakers) on two channels L and R.

There follows a description of a preferred embodiment of the invention, in this case applied to a mobile terminal and in the context of an acoustic spatialization by binaural synthesis.

On telecommunication terminals, mobile in particular, there is naturally provided an acoustic rendition with a stereophonic headset. The preferred acoustic source positioning technique is then binaural synthesis. It consists, for each acoustic source, in filtering the monophonic signal via acoustic transfer functions called HRTFs (for Head Related Transfer Functions), which model the transformations generated by the chest, the head and the auricle of the person hearing the signal originating from a acoustic source. For each position of the space, a pair of these functions (one function for the right ear, one function for the left ear) can be measured. The HRTFs are therefore functions of the position [θ,φ] (where θ represents the bias and p the elevation) and of the acoustic frequency f. There is then obtained, for a given subject, a database of 2M acoustic transfer functions representing each position of the space for each ear (M being the number of directions measured). Conventionally, this technique is implemented in so-called “bicanal” form.

Another binaural synthesis, based on a linear breakdown of the HRTFs, corresponds to an implementation which proves more effective in particular when a number of acoustic sources are spatialized, or in the case where the acoustic sources change position in time. In this case, the term “dynamic binaural synthesis” is used.

These two embodiments of binaural synthesis are described below.

“Bicanal” Binaural Synthesis

Referring to FIG. 3, bicanal binaural synthesis consists in filtering the signal from each source Sᵢ (i=1, 2, . . . , N) that is to be positioned in space at a position [θi,φi], via the left and right acoustic transfer functions (HRTF_l and HRTF_r) corresponding to the appropriate directions [θi,φi] (step 31). Two signals are obtained, which are then added to the left and right signals resulting from the spatialization of the other sources (step 32), to give the L and R signals delivered to the left and right ears of the subject with a stereophonic headset.

It should be indicated that, in this implementation, the positions of the acoustic sources are not felt to change in time. However, if there is a desire to have the positions of the acoustic sources vary in the space over time, it is preferable to modify the filters used to model the left and right HRTFs. However, since these filters take the form of either finite impulse response (FIR) filters or infinite impulse response (IIR) filters, discontinuity problems on the left and right output signals appear, leading to audible “clicks”. The technical solution employed to overcome this problem is to rotate two sets of binaural filters in parallel. The first set simulates the first position [θ1,φ1] at an instant t1, the second the second position [θ2,φ2] at an instant t2. The signal giving the illusion of a movement between the first and second positions is then obtained by a sequenced fading of the left and right signals resulting from the first and second filtering processes. Thus, the complexity of the acoustic source positioning system is then multiplied by two compared to the static case. Furthermore, the number of filters to be implemented is proportional to the number of sources to be spatialized.

If N acoustic sources are considered, the number of filters needed is then 2.N for a static binaural synthesis and 4.N for a dynamic binaural synthesis.

A description of an advantageous variant is given below.

Binaural Synthesis Based on a Linear Breakdown of the HRTFs

It should first be indicated that such an implementation has a complexity that no longer depends on the total number of sources to be positioned in space. In practice, these techniques allow the HRTFs to be broken down on the basis of orthogonal functions, common to all the positions of the space, and therefore no longer depend only on the frequency f. Thus, the number of filters needed is reduced. More particularly, the number of filters is fixed and no longer depends on the number of sources to be positioned, so that adding an additional acoustic source requires only the application of a delay, followed by a multiplication operation by a number of gains dependent only on the position [θ,φ] and an addition operation, as will be seen with reference to FIG. 4. These linear breakdown techniques are also of interest in the case of dynamic binaural synthesis (acoustic source position variable in time). In practice, in this case, the coefficients of the filters are no longer varied, only the values of the gains that are dependent on the position are varied.

The aim of the linear breakdown of the HRTFs is to separate the space and frequency dependencies of the transfer functions. First, the phase excess of the HRTFs is extracted, then modeled in the form of a pure delay τ. The linear breakdown is then applied to the minimal phase component of the HRTFs. Each HRTF is expressed as a sum of P spatial functions Cⱼ(θ,φ) and reconstruction filters Lj(f):

$$HRTF ( θ , φ , f ) = exp ( j 2 π f τ ( θ , φ ) ) \cdot {\sum }_{j = 1}^{P} {C}_{j} ( θ , φ ) {L}_{j} ( f ) \qquad ( 1 )$$

The implementation scheme for binaural synthesis based on a linear breakdown of the HRTFs is illustrated in FIG. 4. The interaural delays τᵢ (step 41) associated with the different sources are first applied to the signal from each source to be spatialized Sᵢ (with i=1, . . . , N). The signal from each source is then broken down into P channels corresponding to the P basic vectors of the linear breakdown. Each of these channels then has applied to it the directional coefficients Cⱼ(θᵢ,φᵢ) (denoted C_{i,j}) derived from the linear breakdown of the HRTFs (step 42). These spatialization parameters τᵢ and C_{i,j} have the particular feature of depending only on the position [φᵢ,φᵢ] where the source is to be placed. They do not depend on the acoustic frequency. For each source, the number of these coefficients corresponds to the number P of the basic vectors that were used for the linear breakdown of the HRTFs.

For each channel, the signals from the N sources are then added (step 43) then filtered (step 44) by the filter Lⱼ(f) corresponding to the j^{th} basic vector.

The same scheme is applied separately for the right and left channels. FIG. 4 distinguishes the delays applied to the left channel (τ_{L}i) and right channel (τ_{R}i), and the directional coefficients applied to the left channel (C_{i,j}) and right channel (D_{i,j}). Finally, the signals summed and filtered in the steps 44 and 45 are summed again (step 45 in FIG. 4), as in the step 32 of FIG. 3, for reproduction on a stereophonic headset. It should be indicated that the steps 41, 42 and 43 can correspond to the spatial encoding proper, for the binaural synthesis, whereas the steps 44 and 45 can correspond to a spatial decoding prior to reproduction, that would be performed by the module M′3 of FIG. 2, as described above. In particular, the signals derived from the summers after the step 43 of FIG. 4 can be carried via a communication network, for a spatial decoding and reproduction on a mobile terminal, in the steps 44 and 45 described above.

The benefit of this implementation is that, unlike the “bicanal” binaural synthesis, the addition of an extra source does not require two additional filters (of FIR or IIR type). In other words, the P basic filters are shared by all the sources present. Furthermore, in the case of dynamic binaural synthesis, it is possible to vary the coefficients Cⱼ(θi,φi) without provoking audible clicks at the output of the device. In this case, only 2.P filters are necessary, whereas 4.N filters were necessary for the dynamic bicanal implementation described above.

In other words, the delays τ and the gains C and D, which constitute the spatialization parameters and are specific to each acoustic source according to its position, can therefore be dissociated from the directional filters L(f) in the implementation of the binaural synthesis based on a linear breakdown of the HRTFs. Consequently, the directional filters are common to the N sources, independently of their position, their number or any movement by them. The application of the spatialization parameters then represents the spatial encoding proper, of the signals relative to the sources themselves, whereas the directional filters perform the actual spatial decoding processing, with a view to reproduction, which no longer depends on the position of the sources, but on the acoustic frequency.

Referring to FIG. 5, this dissociation between the spatialization parameters and the directional filters is advantageously exploited by incorporating the application of the spatialization delay and gain in the acoustic synthesizer. The acoustic synthesis and the spatial encoding (delays and gains) driven by the bias and elevation are thus performed simultaneously within one and the same module such as a sound generator, for each acoustic signal (or note, in music editing) to be generated (step 51). The spatial decoding is then taken over by the directional filters Lᵢ(f), as indicated above (step 52).

There now follows a description, with reference to FIGS. 6 and 7, of the signal generation steps in acoustic synthesis. In particular, FIG. 6 represents the main parameters of an ADSR envelope of the abovementioned type, used commonly in different acoustic synthesis techniques. In particular, FIG. 6 represents the temporal variation of the envelope of a synthesized acoustic signal, for example a note played on a piano, with:
an attack parameter, modeled by an upward ramp 61, corresponding for example to the duration of the pressing of a hammer against a piano string,
a decay parameter, modeled by a downward ramp 62, strongly decreasing, corresponding for example to the duration of a release of a hammer from a piano string,
a sustain parameter (free vibration), modeled by a slightly downward ramp 63, due to the natural acoustic damping, corresponding for example to the duration of a sound of a depressed piano key,
and a release parameter, modeled by a downward ramp 64, corresponding for example to the rapid acoustic damping that a felt produces when applied to a piano string.

Of course, more complex envelope variations can be envisaged, including, for example, more than four phases.

It should, however, be indicated that most of the synthesized sounds can be modeled by an envelope variation as described above. Preferably, the parameters of the ADSR envelope are defined before performing the filterings provided for the spatialization processing, because of the time variables involved.

It will thus be understood that the maximum of the acoustic amplitude (in arbitrary units in FIG. 6) can be defined by the spatialization processing, then mapped to the abovementioned gains Cᵢⱼ and Dᵢⱼ, for each left and right channel. Similarly, the triggering instant of the sound (start of the ramp 61) can be defined through the delays τ_{L}i and τ_{R}i.

Reference is now made to FIG. 7 in which is represented a simple acoustic synthesis operator by frequency modulation (“FM synthesis”). A carrier frequency f_{c} (typically the frequency of the fundamental mode) is initially defined, which defines, for example, the tone of a musical note. One or more oscillators OSC1 are then available to define one or more harmonics fₘ (corresponding in principle to frequencies that are multiples of the carrier frequency f_{c}), with which are associated relative loudnesses Iₘ. For example, the loudnesses Iₘ, relative to the loudness of the fundamental mode, are higher for a metallic sound (such as that produced by a new guitar string). As a general rule, FM synthesis allows the timbre of a synthesized sound to be defined. The signals (sinusoidal) derived from the or each oscillator OSC1 are added to the signal taken from the carrier frequency f_{c} by the module AD, which delivers a signal to an output oscillator OSC2 which receives as set point the amplitude A_{c} of the sound relative to the carrier frequency f_{c}. Here, too, it should be indicated that this set point A_{c} can be directly defined by the spatialization processing, through the gains C and D (in binaural synthesis), as has been seen above. Finally, the oscillator OSC2 delivers a signal S′ᵢ, to which is then applied an ADSR envelope of the type represented in FIG. 6, together with a pair of delays τ_{L}i and τ_{R}i and a number of gains Cᵢⱼ and Dᵢⱼ, respectively for each left and right channel, as represented in FIG. 4, and to finally obtain a signal such as one of the signals delivered by the sound generators of FIG. 5.

It will thus be understood that such a measure makes it possible to avoid, in a particularly advantageous way, generating, from a score in MIDI format, the sounds in a standard audio reproduction format (for example, in “wave” format) and encoding them again for a spatialization of the sound, as in the known implementations.

The present invention allows for the direct and concurrent implementation of the sound spatialization and synthesis steps. It will be understood in particular that any acoustic synthesis processing, requiring the definition of a loudness (and, where appropriate, a triggering instant of the sound), can be performed jointly with a spatialization processing, offering a gain (and, where appropriate, a delay) for each reproduction channel.

As a general rule, a sound synthesizer operates on the basis of reading a score which combines the information on the instruments to be synthesized, the instants at which the sounds must be played, the pitch of these sounds, their strength, etc. When reading this score, each sound is assigned a sound generator, as indicated above with reference to FIG. 5.

Consideration is given first to the case where one and the same source plays a number of notes simultaneously. These notes, which originate from the same source, are spatialized in the same position and therefore with the same parameters. It is then preferred to combine the spatialization processing for the sound generators associated with the same source. In these conditions, the signals associated with the notes obtained from one and the same source are preferably summed first so as to apply the spatialization processing globally to the resultant signal, which, on the one hand, advantageously reduces the implementation cost and, on the other hand, advantageously ensures the consistency of the acoustic scene.

Furthermore, the gains and the delays can be applied by exploiting the structure of the synthesizer. On the one hand, the spatialization delays (left channel and right channel) are implemented in the form of delay lines. On the other hand, in the context of the synthesizer, the delays are managed by the triggering instants of the sound generators in accordance with the score. In the context of a spatialized acoustic synthesis, the two preceding approaches (delay line and control of the triggering instant) are combined so as to optimize the processing. There is therefore a saving of a delay line for each source, by adjusting the triggering instants of the sound generators. To this end, the difference between the delays of the left channel and the right channel for the spatialization is extracted. Provision is then made to add the smaller of the two delays to the triggering instant of the generator. It then remains to apply the time difference between the left and right channels to just one of the two channels, in the form of a delay line, it being understood that this delay difference can have positive or negative values.

With respect to the gains, the balance (or “pan”) parameter, which is typically associated with the stereophonic system, is no longer needed. It is therefore possible to eliminate the gains associated with balance. Furthermore, the volume parameter of the sound generator can be applied to the level of the various gains corresponding to the spatial encoding, as described above.

It should also be indicated that the present invention allows the acoustic spatialization to be applied, source by source, because of the fact that the spatialization tool is incorporated in the core of the acoustic synthesis engine. Such is not the case if, on the contrary, the chosen method is to simply cascade the synthesis engine with the spatialization tool. In this case, in practice, it should be remembered that the spatialization can be applied only globally to all the acoustic scene.

According to another advantage of the present invention, the acoustic synthesis and spatialization tools can be judiciously combined to produce an optimized implementation of a spatialized acoustic synthesis engine, with, in particular, an optimization of the combination of the synthesis and spatialization operations, taking into account in particular at least one spatialization gain and/or delay, or even a spatialization filter.

In the case where the synthesis parameters already apply one or more of these parameters (gain, delay, filter), the spatialization filters are advantageously taken into account by simply modifying the synthesis parameters, without modifying the synthesis model itself.

Moreover, by simply adding a gain and a delay to the acoustic synthesis engine, where necessary complemented with a filter, a spatialized acoustic synthesis, based on different possible spatialization techniques, can be obtained. These spatialization techniques (binaural/transaural synthesis, holophony, ambisony, etc.) can be of variable complexity and efficiency but overall offer a far richer and more comprehensive spatialization than stereophony, with, in particular, a natural and particularly immersive rendition of the acoustic scene. In practice, the inventive acoustic spatialization retains all the potential of a three dimensional acoustic rendition, in particular in terms of immersion, with genuine 3D spatialization.

Of course, it is also possible to provide for an integration of the spatialization and room effect processing, in the simplified form of at least one gain and/or one delay (where appropriate complemented with filters), and an artificial reverberator for the delayed reverberation.

1. An acoustic synthesis and spatialization method, in which a synthetic sound to be generated is characterized by the nature of a virtual acoustic source and its position relative to a chosen origin,
wherein the method comprises a joint step of determining parameters including at least one gain, for defining, at the same time:
a loudness characterizing the nature of the source, and
the position of the source relative to a predetermined origin.

2. The method as claimed in claim 1, in which the spatialization of the virtual source is performed in an ambisonic context, further comprising a step for calculating gains associated with ambisonic components in a spherical harmonics base.

3. The method as claimed in claim 1, in which the synthetic sound is intended to be reproduced in a holophonic, or binaural, or transaural context, on a plurality of reproduction channels,
wherein, during said joint step, a delay between reproduction channels is also determined, to define at the same time:
a triggering instant of the sound characterizing the nature of the source, and
the position of the source relative to a predetermined origin.

4. The method as claimed in claim 3, wherein the nature of the virtual source is parameterized at least by a temporal loudness variation, over a chosen duration and including a sound triggering instant.

5. The method as claimed in claim 4, wherein said variation comprises at least:
an instrumental attack phase,
a decay phase,
a sustain phase, and
a release phase.

6. The method as claimed in claim 3, wherein the spatialization of the virtual source is performed by a binaural synthesis based on a linear breakdown of transfer functions, these transfer functions being expressed by a linear combination of terms dependent on the frequency of the sound and weighted by terms dependent on the direction of the sound.

7. The method as claimed in claim 6, wherein the direction is defined by at least one bias angle and, preferably, by a bias angle and an elevation angle.

8. The method as claimed in claim 6, wherein the position of the virtual source is parameterized at least by:
a number of filterings, dependent on the acoustic frequency,
a number of weighting gains each associated with a filtering, and
a delay for each “left” and “right” channel.

9. The method as claimed in claim 1, wherein the nature of the virtual source is parameterized by at least one acoustic timbre, by associating the chosen relative loudnesses with harmonics of a frequency corresponding to a pitch of the sound.

10. The method as claimed in claim 1, wherein the method provides for an acoustic synthesis engine to generate spatialized sounds, relative to said predetermined origin.

11. The method as claimed in claim 10, in which the synthesis engine is implemented in a music editing context, wherein the method also provides for a man-machine interface to place the virtual source in a chosen position relative to the predetermined origin.

12. The method as claimed in claim 11, in which a plurality of virtual sources to be synthesized and spatialized are provided, wherein each source is assigned to a respective position.

13. A module for generating synthetic sounds, comprising in particular a processor, wherein it also includes a working memory for storing instructions for implementing an acoustic synthesis and spatialization method, in which a synthetic sound to be generated is characterized by the nature of a virtual acoustic source and its position relative to a chosen origin,
the method comprising a joint step of determining parameters including at least one gain, for defining, at the same time:
a loudness characterizing the nature of the source, and
the position of the source relative to a predetermined origin.

14. A computer program product, stored in a memory of a central processing unit or a terminal, in particular a mobile terminal, or on a removable medium specifically for cooperating with a drive of said central processing unit, comprising instructions for implementing an acoustic synthesis and spatialization method, in which a synthetic sound to be generated is characterized by the nature of a virtual acoustic source and its position relative to a chosen origin,
the method comprising a joint step of determining parameters including at least one gain, for defining, at the same time:
a loudness characterizing the nature of the source, and
the position of the source relative to a predetermined origin.

15. A communication terminal, including a module for generating synthetic sounds comprising a processor and a working memory for storing instructions for implementing an acoustic synthesis and spatialization method, in which a synthetic sound to be generated is characterized by the nature of a virtual acoustic source and its position relative to a chosen origin,
the method comprising a joint step of determining parameters including at least one gain, for defining, at the same time:
a loudness characterizing the nature of the source, and
the position of the source relative to a predetermined origin.
